(19) United States
(12) Patent Application Publication
(10) Pub. No.: US 2026/0087405 A1
(43) Pub. Date: Mar. 26, 2026

(54) THREADED CONNECTION EVALUATION WITH MACHINE LEARNING

(71) Applicant: WEATHERFORD TECHNOLOGY HOLDINGS, LLC, HOUSTON, TX (US)

(72) Inventors: Rainer RUEHMANN, Hannover (DE); Benjamin SACHTLEBEN, Hannover (DE); David GEISSLER, Hannover (DE)

(21) Appl. No.: 18/908,014

(22) Filed: Oct. 7, 2024

Related U.S. Application Data
(60) Provisional application No. 63/697,868, filed on Sep. 23, 2024.

(51) Int. Cl. G06N 20/00; E21B 19/16

(52) U.S. Cl. CPC G06N 20/00; E21B 19/166; E21B 2200/22

(57) ABSTRACT

A method for evaluating threaded connections can include transmitting model parameters from one artificial intelligence to another intelligence, inputting torque and rotation measurements to the second artificial intelligence, and updating the first artificial intelligence using data transmitted from a job location. An apparatus for evaluating threaded connections can include a first artificial intelligence trained to predict threaded connection quality, and a second artificial intelligence configured to receive model parameters from the first artificial intelligence, the second artificial intelligence being configured to predict threaded connection quality while the second artificial intelligence is not in communication with the first artificial intelligence.

### CROSS-REFERENCE TO RELATED APPLICATION

This application claims the benefit of the filing date of US provisional application no. 63/697,868 filed on 23 September 2024. The entire disclosure of the prior application is incorporated herein by this reference for all purposes.

### BACKGROUND

This disclosure relates generally to equipment utilized and operations performed in conjunction with a subterranean well and, in an example described below, more particularly provides for threaded connection evaluation with machine learning.

Various types of tubular components can be threaded together to form tubular strings for use in a well. Tubulars used in wells can include protective wellbore linings (such as, casing, liner, etc.), production or injection conduits (such as, production tubing, injection tubing, screens, etc.), drill pipe and drill collars, and associated components (such as tubular couplings).

Threaded connections between tubulars are made-up during tubular running operations, and the threaded connections are broken-out when a tubular string is retrieved from a well. The make-up and break-out processes should be performed quickly, efficiently and safely.

It will, therefore, be readily appreciated that improvements are continually needed in the art of evaluating threaded connection quality at a well. The present disclosure provides such improvements to the art.

### BRIEF DESCRIPTION OF THE DRAWINGS

FIG. 1 is a representative partially cross-sectional view of an example of a well system and associated method which can embody principles of this disclosure.

FIG. 2 is a representative side view of an example tong assembly and apparatus for evaluating threaded connection quality.

FIG. 3 is a representative schematic view of an example of an artificial intelligence of the apparatus.

FIG. 4 is a representative schematic view of an example of a system for continuous training and updating of artificial intelligences.

FIG. 5 is a representative flowchart for an example of a method of evaluating threaded connections.

### DETAILED DESCRIPTION

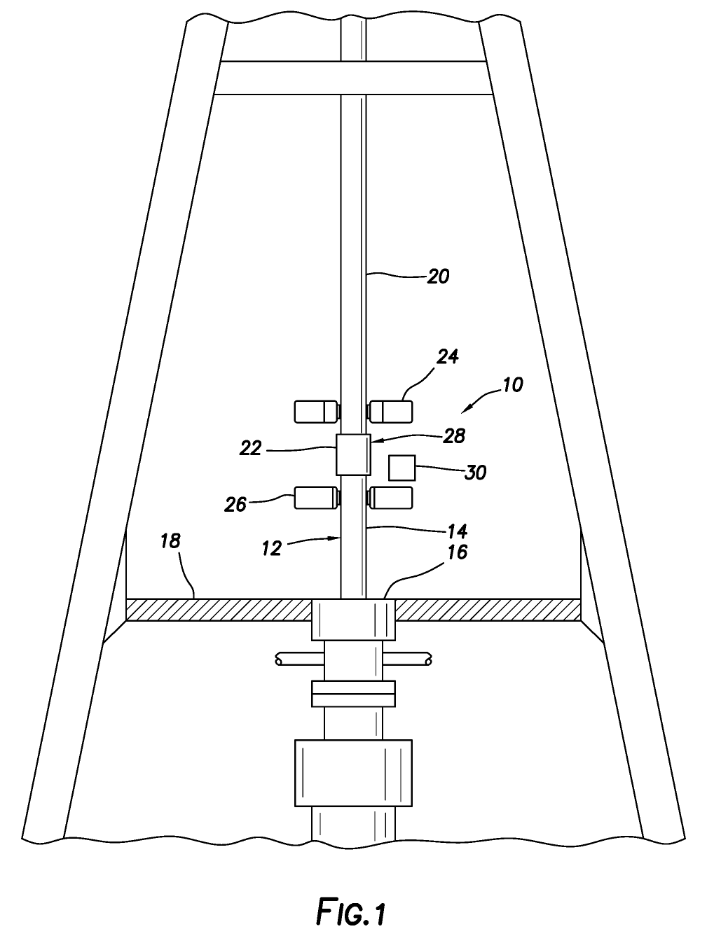

Representatively illustrated in FIG. 1 is a system 10 for use with a subterranean well, and an associated method, which can embody principles of this disclosure. However, it should be clearly understood that the well system 10 and method are merely one example of an application of the principles of this disclosure in practice, and a wide variety of other examples are possible. Therefore, the scope of this disclosure is not limited at all to the details of the well system 10 and method described herein and/or depicted in the drawings.

In the FIG. 1 example, a tubular string 12 is being assembled and deployed into a well. The tubular string 12 in this example is a production or injection tubing string, but in other examples the tubular string could be a casing, liner, drill pipe, completion, stimulation, testing or other type of tubular string. The scope of this disclosure is not limited to use of any particular type of tubular string, or to any particular tubular components connected in a tubular string.

As depicted in FIG. 1, a tubular 14 is suspended near its upper end by means of a rotary table 16, which may comprise a pipe handling spider and/or safety slips to grip the tubular 14 and support a weight of the tubular string 12. In this manner, the upper end of the tubular 14 extends upwardly through a rig floor 18 in preparation for connecting another tubular 20 to the tubular string 12.

In this example, a tubular coupling 22 is made-up to the upper end of the tubular 14 prior to the tubular 14 being connected in the tubular string 12. The coupling 22 is internally threaded in each of its opposite ends.

In conventional well operations, it is common for a threaded together tubular and coupling to be referred to as a “joint” and for threaded together joints to be referred to as a “stand” of tubing, casing, liner, pipe, etc. However, in some examples, a separate coupling may not be used; instead one end (typically an upper “box” end of a joint) is internally threaded and the other end (typically a lower “pin” end of the joint) is externally threaded, so that successive joints can be threaded directly to each other.

Thus, the scope of this disclosure can encompass the use of a separate coupling with a tubular, or the use of a tubular without a separate coupling (in which case the coupling can be considered to be integrally formed with, and a part of, the tubular). In the FIG. 1 example, the coupling 22 can also be considered to be a tubular, since it is a tubular component connected in the tubular string 12.

To make-up a threaded connection 28 between the tubular 20 and the coupling 22, a set of tongs or rotary and backup clamps 24, 26 are used. The rotary clamp 24 in the FIG. 1 example is used to grip, rotate and apply torque to the upper tubular 20 as it is threaded into the coupling 22.

The backup clamp 26 in the FIG. 1 example is used to grip and secure the lower tubular 14 against rotation, and to react the torque applied by the rotary clamp 24. The rotary clamp 24 and the backup clamp 26 may be separate devices, or they may be components of a rig apparatus known to those skilled in the art as an “iron roughneck” or a tong assembly.

In one example, the rotary clamp 24 and backup clamp 26 may be components of a tong system, such as the VERO(TM) tong system marketed by Weatherford International, Inc. of Houston, Texas USA. In this example, the rotary clamp 24 may be a mechanism of the tong system that rotates and applies torque to the upper tubular 20, and the backup clamp 26 may be a backup mechanism of the tong system that reacts the applied torque and prevents rotation of the lower tubular 14.

Note that it is not necessary for the tubulars 14, 20 (and coupling 22, if used) to be vertical in the tubular make-up operation. The tubulars 14, 20 could instead be horizontal or otherwise oriented. Additional systems in which the principles of this disclosure may be incorporated include the CAM(TM), COMCAM(TM) and TORKWRENCH(TM) bucking systems marketed by Weatherford International, Inc.

After the upper tubular 20 is properly made-up to the lower tubular 14 or coupling 22, the tubular string 12 can be lowered further into the well, and the make-up operation can be repeated to connect another stand to the upper end of the tubular string. In this manner, the tubular string 12 is progressively deployed into the well by connecting successive stands to the upper end of the tubular string. In some examples, an individual tubular component may be added to the tubular string 12, instead of a stand.

In the FIG. 1 method, it is desired to be able to evaluate a quality of the threaded connection 28 when it is made-up. In this manner, if the threaded connection 28 is acceptable, the tubular string 12 running operation can proceed efficiently. A next threaded connection 28 can then be made-up and evaluated. Preferably the evaluations of the threaded connections 28 are performed automatically, in real time, and without the need for personnel to be present on the rig floor 18.

An apparatus 30 is included in the FIG. 1 system 10 for evaluating the threaded connections 28. As described more fully below, the apparatus 30 can include a variety of different sensors to obtain measurements used by a trained artificial intelligence to predict threaded connection quality.

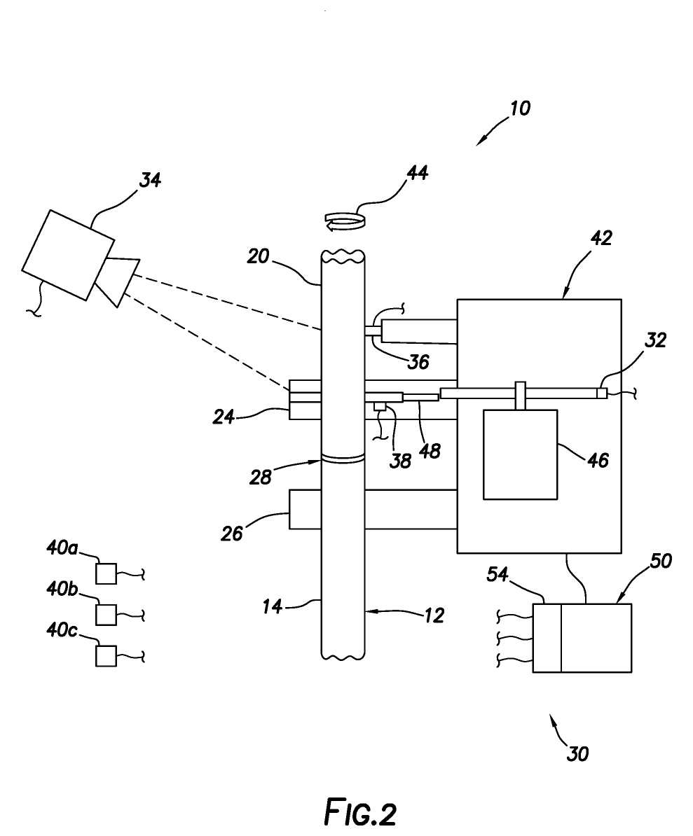

Referring additionally now to FIG. 2, an example of the apparatus 30 as used with the FIG. 1 system 10 and method is representatively illustrated. However, the apparatus 30 may be used with other systems and methods in keeping with the principles of this disclosure.

In the FIG. 2 example, a variety of different sensors 32, 34, 36, 38, 40 measure conditions, parameters, etc., associated with a tubular running operation. As depicted in FIG. 2, the sensor 32 is a rotation sensor, the sensor 34 is an optical sensor, the sensor 36 is a rotation sensor, the sensor 38 is a torque sensor, and the sensors 40a-c comprise environmental (such as, temperature, humidity and salt content) sensors. Other sensors, numbers of sensors, and combinations of sensors can be used in other examples for measurement of other conditions, parameters, etc.

The rotation sensor 32 outputs measurements of rotation of a motor 46 of a tong assembly 42. The rotation (and torque) output by the motor 46 is transmitted via a gear train 48 to the rotary clamp 24. Thus, the rotation output by the motor 46 and measured using the sensor 32 is directly related to the rotation of the rotary clamp 24 and the upper tubular 20 in a make-up process.

The optical sensor 34 may comprise, for example, a camera or a laser measurement device (such as, employing light detection and ranging (LiDAR)) or a terahertz scanner. Image data output by the sensor 34 can be used to identify the locations of the tubulars 14, 20, certain features of the tubulars (such as, an upper end of the lower tubular), and rotation of one or both of the tubulars.

The rotation sensor 36 outputs direct measurements of the rotation 44 of the upper tubular 20. In this example, the sensor 36 contacts an outer surface of the upper tubular 20 with a roller, and since rotation of the roller is directly related to the rotation 44 of the tubular 20, measurements of the roller rotation output by the sensor 36 are equivalent to measurements of the tubular rotation 44.

The torque sensor 38 is configured and arranged to measure the torque applied by the rotary clamp 24 to the upper tubular 20. In this example, the torque is measured on an output side of the gear train 48, but in other examples the torque may be measured on an input side of the gear train, or at other locations.

In the FIG. 2 example, the environmental sensors 40a-c measure various environmental parameters that can affect the threaded connection make-up process. For example, the sensor 40a may comprise a temperature sensor or thermometer, thermocouple, etc. The sensor 40b may comprise a humidity sensor or hygrometer. The sensor 40c may comprise a salinometer or salinity sensor capable of measuring salt content. Other environmental sensors, numbers and combinations of sensors may be used in other examples.

A control system 50 is used to control operations in the tubular make-up process (e.g., completely automatically, or with human participation). For example, the control system 50 may be in wired or wireless communication with the tong assembly 42 to thereby control operation of the tong assembly during the make-up process. The control system 50 may also control operation of the tong assembly 42 during any tubular break-out operations, for example, when retrieving the tubular string 12 from the well.

The control system 50 in this example includes an artificial intelligence 54 that receives the measurement outputs from each of the sensors 32, 34, 36, 38, 40a-c during the make-up process. In one example, the sensor measurements are received in real time, while the make-up is being performed, or at least while rotation and torque are being applied to the upper tubular 20. In this manner, an evaluation of the quality of the threaded connection 28 can be quickly provided (e.g., as soon as the make-up is finished), thereby enhancing the speed and efficiency of the tubular running operation.

The evaluation of the threaded connection quality is performed using the artificial intelligence 54. The artificial intelligence 54 is trained, or at least provided with initial model parameters, so that the artificial intelligence can predict tubular connection quality in response to appropriate inputs related to a particular threaded connection make-up.

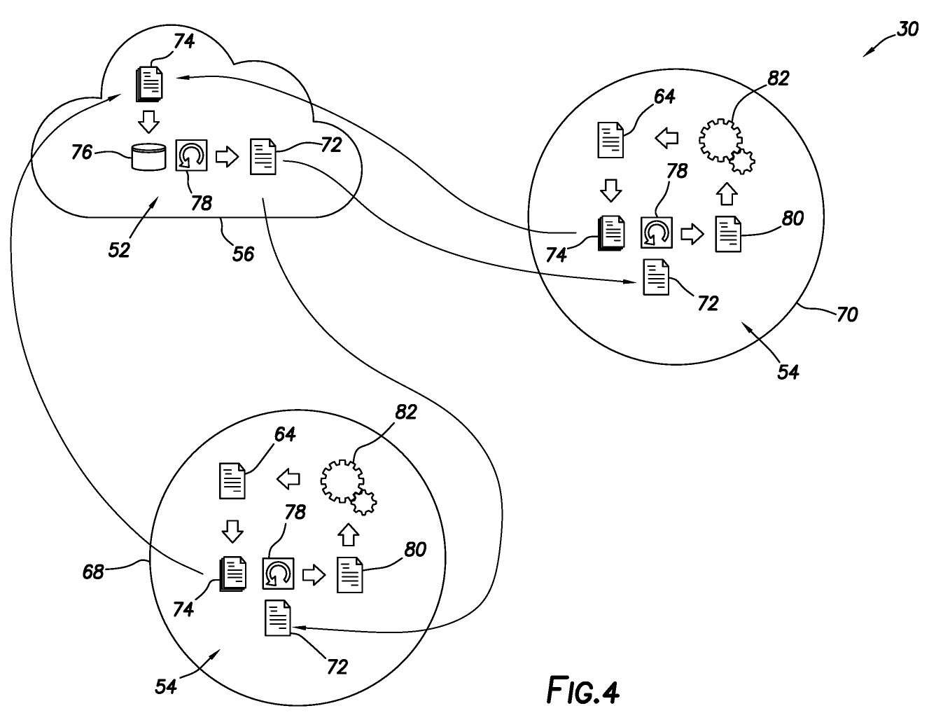

In this example, the artificial intelligence 54 at a particular job location is supplied with initial model parameters from another artificial intelligence 52 on a central server 56 (see FIG. 4). The initial model parameters may be transmitted to the artificial intelligence 54 before or after the artificial intelligence 54 is transported to the job location.

The artificial intelligences 52, 54 may be implemented in software, firmware, hardware or in any combination. The artificial intelligences 52, 54 may comprise any suitable type of artificial intelligence, such as, neural networks, genetic algorithms, machine learning, etc. The initial model parameters can comprise, for example, “weights” assigned for a neural network model.

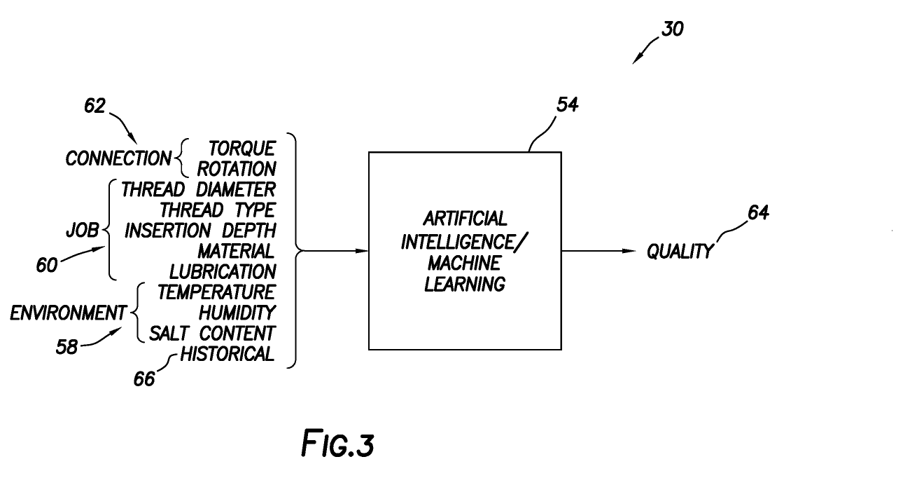

Referring additionally now to FIG. 3, an example of the artificial intelligence 54 of the apparatus 30 is representatively illustrated. In this example, the artificial intelligence 54 is depicted as having certain inputs and an output. Other inputs and outputs may be used in other examples.

As depicted in FIG. 3, the inputs to the artificial intelligence 54 include environmental measurements 58, relevant job information 60 and sensor measurements 62 for each threaded connection 28. After the artificial intelligence 54 has been provided with the initial parameters, or has otherwise been suitably trained, the artificial intelligence can predict or estimate the tubular connection quality in response to the inputs 58, 60, 62.

In the FIG. 3 example, the environmental measurements 58 include temperature, humidity and salt content output from the respective sensors 40a-c. The job information 60 includes thread diameter, thread type, insertion depth, material and lubrication, each of which may change during a tubular running operation. The connection measurements 62 include torque and rotation measurements output from the sensors 32, 34, 36, 38.

The environmental measurements 58, job information 60, connection measurements 62 and threaded connection quality evaluation 64 can be used, along with prior historical data 66, to further train the artificial intelligence 54. In this manner, the accuracy of the quality evaluations 64 will improve over time. This further training can be performed after each threaded connection 28 is made-up, after each job is concluded, or at other selected times. This further training can be performed while the artificial intelligence 54 is connected to, or in communication with, the artificial intelligence 52 at the central server 56 (such as, via the Internet, wired or wireless communication, etc.), or while the artificial intelligences 52, 54 are not connected to, or in communication with, each other.

Referring additionally now to FIG. 4, an example of the apparatus 30 is schematically illustrated, in which multiple artificial intelligences 54 at respective remote job locations 68, 70 are in communication with the artificial intelligence 52 at the central server 56 (represented as a “cloud” in FIG. 4). The communication between the artificial intelligences 52, 54 enables model parameters 72 to be used to initiate the training of the artificial intelligences 54, or to update the artificial intelligences 54 after the initial training. However, as mentioned above, the artificial intelligences 54 at the job locations 68, 70 can continue to be trained (e.g., including machine learning), even if there is no connection or communication between the artificial intelligences 52, 54 (such as, using locally available environmental measurements 58, job information 60, connection measurements 62 and historical data 66, see FIG. 3).

When the artificial intelligences 52, 54 are connected or in communication with each other, the artificial intelligences 54 can transmit to the artificial intelligence 52 accumulated job data 74 at a conclusion of each job. The job data 74 can include the environmental measurements 58, job information 60 and connection measurements 62 and threaded connection quality evaluations 64 for a particular job. The job data 74 is added to a central database 76 maintained on the central server 56 in this example.

The artificial intelligence 52 uses the database 76 for further machine learning or training 78, in order to improve its estimations or predictions of threaded connection quality 64. The training 78 produces updated model parameters 72, which are transmitted to the remote artificial intelligences 54. In this manner, the remote artificial intelligences 54 can benefit from the further training 78 and updating of the central artificial intelligence 52.

In situations in which the training 78 is performed at a remote artificial intelligence 54 (such as, when there is no communication between the artificial intelligences 52, 54), locally generated updated model parameters 80 can be used for threaded connection quality evaluating 82 by the artificial intelligence 54. When communication between the artificial intelligences 52, 54 is available, the job data 74 (including, for example, the updated model parameters 80 and quality evaluations 64) can be transmitted from the artificial intelligence 54 to the artificial intelligence 52.

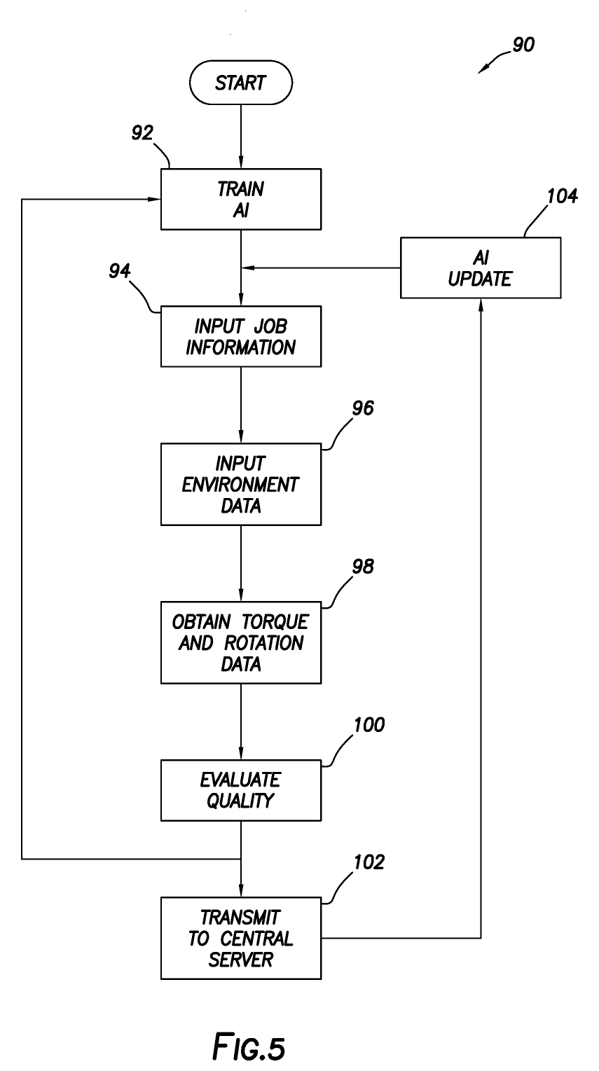

Referring additionally now to FIG. 5, an example of a method 90 of evaluating threaded connections is representatively illustrated in flowchart form. For convenience, the method 90 is described below as it may be used with the FIGS. 1-4 system 10, apparatus 30 and method. However, the method 90 may be used with other systems, apparatus and/or methods in keeping with the scope of this disclosure.

In step 92, an artificial intelligence 54 is trained to estimate or predict threaded connection quality (e.g., whether a particular threaded connection 28 is acceptable or not acceptable). The artificial intelligence 54 may be trained using initial model parameters 72 transmitted from another artificial intelligence 52 on a central server 56. Alternatively, or in addition, the artificial intelligence 54 may be trained using locally obtained job data 74 (including for example, environmental measurements 58, job information 60, connection measurements 62 and historical data 66).

In step 94, job information 60 is input to the artificial intelligence 54. The job information 60 is specific to a particular job or tubular running operation, although it is possible that the job information can change at some point in the job. The job information 60 may include, for example, thread diameter, thread type, insertion depth, material and lubrication. Other job information may be input to the artificial intelligence 54 in other examples.

In step 96, environmental measurements 58 are input to the artificial intelligence 54. The environmental measurements 58 are expected to change continuously during a job, and so the capability of the apparatus 30 to adapt to such changing conditions, and to provide evaluations of threaded connection quality in real time, can be very beneficial. In this example, the environmental measurements 58 may include temperature, humidity and salt content measurements output by the sensors 40a-c, but other measurements may be used in other examples.

In step 98, connection measurements 62 are input to the artificial intelligence 54. The connection measurements 62 are specific to a make-up of a particular threaded connection 28. In this example, the connection measurements 62 may include torque and rotation measurements output by the sensors 32, 34, 36, 38. Other measurements may be used in other examples.

In step 100, the artificial intelligence 54 produces a threaded connection quality evaluation 64 for the threaded connection 28 for which the connection measurements 62 were made in step 98. The evaluation 64 preferably is provided in real time, so a decision can be readily made whether to accept or reject the threaded connection 28.

Once the evaluation 64 is made, the artificial intelligence 54 can be further trained remotely (e.g., at the job location 68), using the environmental measurements 58, job information 60, connection measurements 62 and quality evaluation 64 as historical data 66. In this manner, the artificial intelligence 54 can continuously improve its quality evaluation 64 outputs, even if the artificial intelligence 54 is not in communication with the central artificial intelligence 52.

In step 102, the job data 74 (e.g., including the environmental measurements 58, job information 60, connection measurements 62 and quality evaluations 64) are transmitted to the central artificial intelligence 52. This transmission of the job data 74 may occur at a conclusion of a job, or whenever convenient and when the artificial intelligences are in communication with each other.

In step 104, the central artificial intelligence 52 is updated by performing further training (e.g., machine learning) using the job data 74 received from one or more remote artificial intelligences 54. This further training generates updated model parameters 72, which are then transmitted to the remote artificial intelligences 54. This transmission of the updated model parameters 72 may occur at a conclusion of a job, or whenever convenient and when the artificial intelligences are in communication with each other. An artificial intelligence 54 can then use the updated model parameters 72 to evaluate a next threaded connection 28 on the same or a different job.

It may now be fully appreciated that the above disclosure provides significant advancements to the art of evaluating threaded connection quality at a well. In examples described above, the artificial intelligence 54 can be trained to evaluate the quality of a threaded connection 28 in real time, and can account for changing environmental conditions and job specifics in making the evaluation.

The above disclosure provides to the art a method 90 of evaluating threaded connections 28 for use with a subterranean well. In one example, the method 90 can comprise: training a first artificial intelligence 52 on a central server 56 to predict threaded connection quality; transmitting model parameters 72 from the first artificial intelligence 52 to a second artificial intelligence 54; transporting the second artificial intelligence 54 to a job location 68 remote from the central server 56; inputting first torque and rotation measurements to the second artificial intelligence 54, the second artificial intelligence 54 thereby predicting a quality of a first threaded connection 28 at the job location 68; transmitting data 74 from the job location 68 to the central server 56; and updating the first artificial intelligence 52 using the data 74 transmitted from the job location 68.

The method 90 may include, after the updating step, transmitting updated model parameters 72 from the first artificial intelligence 52 to the second artificial intelligence 54. The method 90 may include, after the transmitting of the updated model parameters 72, inputting second torque and rotation measurements to the second artificial intelligence 54, whereby the second artificial intelligence 54 predicts a quality of a second threaded connection 28 at the job location.

The method may include training the second artificial intelligence 54 using the first torque and rotation measurements 62 and the predicted quality 64 of the first threaded connection 28.

The predicting step may be performed while the second artificial intelligence 54 is not in communication with the first artificial intelligence 52. The predicting step may be performed while the job location 68 is not connected via Internet with the central server 56.

The inputting step may include inputting environmental measurements 58 to the second artificial intelligence 54. The environmental measurements 58 may include temperature, humidity and/or salt content.

The inputting step may include inputting job information 60 to the second artificial intelligence 54. The job information 60 may include thread diameter, thread type, insertion depth, material and/or lubrication.

The inputting step may include inputting historical data 66 to the second artificial intelligence 54.

The transporting step may be performed prior to the step of transmitting the model parameters 72 from the first artificial intelligence 52 to the second artificial intelligence 54.

The above disclosure also provides to the art an apparatus 30 for evaluating threaded connections 28 for use with a subterranean well. In one example, the apparatus 30 can comprise a first artificial intelligence 52 trained to predict threaded connection quality; a second artificial intelligence 54 configured to receive model parameters 72 from the first artificial intelligence 52, whereby the second artificial intelligence 54 is capable of predicting threaded connection quality, and in which the second artificial intelligence 54 is configured to predict threaded connection quality while the second artificial intelligence 54 is not in communication with the first artificial intelligence 52.

The apparatus 30 may include a torque sensor 38, and a rotation sensor 32, 34, 36. The second artificial intelligence 54 may be configured to predict threaded connection quality in response to input of measurements 62 from the torque and rotation sensors 32, 34, 36, 38.

The second artificial intelligence 54 may be configured to predict threaded connection quality in response to input of torque and rotation measurements 62 in real time during a threaded connection 28 make-up process. The second artificial intelligence 54 may be configured to predict threaded connection quality further in response to input of environmental measurements 58. The environmental measurements 58 may include temperature, humidity and/or salt content.

The second artificial intelligence 54 may be configured to predict threaded connection quality further in response to input of job information 60 to the second artificial intelligence 54. The job information 60 may include thread diameter, thread type, insertion depth, material and/or lubrication.

The second artificial intelligence 54 may be configured to predict threaded connection quality while the second artificial intelligence 54 is not connected via Internet with the first artificial intelligence 52.

The first artificial intelligence 52 may be configured to receive job data 74 from the second artificial intelligence 54. The first artificial intelligence 52 may be further configured to update the model parameters 72 in response to input of the job data 74 to the first artificial intelligence 52.

Although various examples have been described above, with each example having certain features, it should be understood that it is not necessary for a particular feature of one example to be used exclusively with that example. Instead, any of the features described above and/or depicted in the drawings can be combined with any of the examples, in addition to or in substitution for any of the other features of those examples. One example’s features are not mutually exclusive to another example’s features. Instead, the scope of this disclosure encompasses any combination of any of the features.

Although each example described above includes a certain combination of features, it should be understood that it is not necessary for all features of an example to be used. Instead, any of the features described above can be used, without any other particular feature or features also being used.

It should be understood that the various embodiments described herein may be utilized in various orientations, such as inclined, inverted, horizontal, vertical, etc., and in various configurations, without departing from the principles of this disclosure. The embodiments are described merely as examples of useful applications of the principles of the disclosure, which is not limited to any specific details of these embodiments.

In the above description of the representative examples, directional terms (such as “above,” “below,” “upper,” “lower,” “upward,” “downward,” etc.) are used for convenience in referring to the accompanying drawings. However, it should be clearly understood that the scope of this disclosure is not limited to any particular directions described herein.

The terms “including,” “includes,” “comprising,” “comprises,” and similar terms are used in a non-limiting sense in this specification. For example, if a system, method, apparatus, device, etc., is described as “including” a certain feature or element, the system, method, apparatus, device, etc., can include that feature or element, and can also include other features or elements. Similarly, the term “comprises” is considered to mean “comprises, but is not limited to.”

Of course, a person skilled in the art would, upon a careful consideration of the above description of representative embodiments of the disclosure, readily appreciate that many modifications, additions, substitutions, deletions, and other changes may be made to the specific embodiments, and such changes are contemplated by the principles of this disclosure. For example, structures disclosed as being separately formed can, in other examples, be integrally formed and vice versa. Accordingly, the foregoing detailed description is to be clearly understood as being given by way of illustration and example only, the spirit and scope of the invention being limited solely by the appended claims and their equivalents.

What is claimed is:

1.A method of evaluating threaded connections for use with a subterranean well, the method comprising:
training a first artificial intelligence on a central server to predict threaded connection quality;
transmitting model parameters from the first artificial intelligence to a second artificial intelligence;
transporting the second artificial intelligence to a job location remote from the central server;
inputting torque and rotation measurements to the second artificial intelligence, the second artificial intelligence thereby predicting a quality of a threaded connection at the job location;
transmitting data from the job location to the central server; and
updating the first artificial intelligence using the data transmitted from the job location.

2.The method of claim 1, further comprising, after the updating, transmitting updated model parameters from the first artificial intelligence to the second artificial intelligence.

3.The method of claim 1, further comprising training the second artificial intelligence using the torque and rotation measurements and the predicted quality of the threaded connection.

4.The method of claim 1, in which the predicting is performed while the second artificial intelligence is not in communication with the first artificial intelligence.

5.The method of claim 1, in which the predicting is performed while the job location is not connected via Internet with the central server.

6.The method of claim 1, in which the inputting comprises inputting environmental measurements to the second artificial intelligence.

7.The method of claim 6, in which the environmental measurements are selected from the group consisting of temperature, humidity and salt content.

8.The method of claim 1, in which the inputting comprises inputting job information to the second artificial intelligence.

9.The method of claim 8, in which the job information is selected from the group consisting of thread diameter, thread type, insertion depth, material and lubrication.

10.The method of claim 1, in which the inputting comprises inputting historical data to the second artificial intelligence.

11.An apparatus for evaluating threaded connections for use with a subterranean well, the apparatus comprising:
a first artificial intelligence trained to predict threaded connection quality;
a second artificial intelligence configured to receive model parameters from the first artificial intelligence, whereby the second artificial intelligence is capable of predicting threaded connection quality, and
in which the second artificial intelligence is configured to predict threaded connection quality while the second artificial intelligence is not in communication with the first artificial intelligence.

12.The apparatus of claim 11, further comprising a torque sensor, and a rotation sensor, and in which the second artificial intelligence is configured to predict threaded connection quality in response to input of measurements from the torque and rotation sensors.

13.The apparatus of claim 11, in which the second artificial intelligence is configured to predict threaded connection quality in response to input of torque and rotation measurements in real time during a threaded connection make-up process.

14.The apparatus of claim 11, in which the second artificial intelligence is configured to predict threaded connection quality further in response to input of environmental measurements.

15.The apparatus of claim 14, in which the environmental measurements are selected from the group consisting of temperature, humidity and salt content.

16.The apparatus of claim 11, in which the second artificial intelligence is configured to predict threaded connection quality further in response to input of job information to the second artificial intelligence.

17.The apparatus of claim 16, in which the job information is selected from the group consisting of thread diameter, thread type, insertion depth, material and lubrication.

18.The apparatus of claim 11, in which the second artificial intelligence is configured to predict threaded connection quality while the second artificial intelligence is not connected via Internet with the first artificial intelligence.

19.The apparatus of claim 11, in which the first artificial intelligence is configured to receive job data from the second artificial intelligence.

20.The apparatus of claim 19, in which the first artificial intelligence is further configured to update the model parameters in response to input of the job data to the first artificial intelligence.
